(19) United States
(12) Patent Application Publication
(10) Pub. No.: US 2026/0129124 A1
(43) Pub. Date: May 7, 2026

(54) UPDATING A USER PROFILE AND ROUTING AN INCOMING VOICE CALL BASED ON END USER DATA

(71) Applicant: Twilio Inc, San Francisco, CA (US)

(72) Inventors: Christer Fahlgren, San Francisco, CA (US); Srikanth Subramanian, Bangalore (IN); Doo San Baik, New York, NY (US); Dipesh Chauhan, San Francisco, CA (US); Austin Park, San Francisco, CA (US)

(21) Appl. No.: 18/938,144

(22) Filed: Nov. 5, 2024

(51) Int. Cl. H04M 3/51; H04L 51/02; H04M 7/00

(52) U.S. Cl. CPC H04M 3/5191; H04L 51/02; H04M 3/5166; H04M 7/0021; H04M 7/0036

(57) ABSTRACT

An indication of an incoming voice call from a first telephone number associated with an end user device and to a second telephone number associated with a client organization of the software as a service (SaaS) platform is received at a SaaS platform. Responsive to receiving the indication of the incoming voice call, end user data associated with the first telephone number is identified. A first communication service, among a plurality of communication services, is identified based on an evaluation of the end user data in view of one or more first conditions defined by the client organization. The incoming voice call is routed to the first communication service.

### TECHNICAL FIELD

Aspects and embodiments of the disclosure relate to computer software, and more specifically, to systems and methods for routing an incoming voice call and/or updating a user profile based on end user data.

### BACKGROUND

Voice calls can involve the transmission of audio data over a network, typically utilizing Voice over IP (VoIP) and/or traditional Public Switched Telephone Network (PSTN) systems. In VoIP, voice data is converted into digital packets and transmitted over IP networks, while PSTN relies on circuit-switched technology. Routing voice calls to voice services, such as automated response systems, call centers, or voicemail, involves directing the call through a series of network nodes, gateways, and servers.

### BRIEF DESCRIPTION OF THE DRAWINGS

Aspects and embodiments of the disclosure will be understood more fully from the detailed description given below and from the accompanying drawings of various aspects and embodiments of the disclosure, which, however, should not be taken to limit the disclosure to the specific aspects or embodiments, but are for explanation and understanding.

FIG. 1 illustrates an example system architecture, in accordance with some embodiments of the disclosure.

FIG. 2 illustrates an example system architecture used for routing a communication and updating a user profile, in accordance with some embodiments of the disclosure.

FIG. 3 illustrates a sequence diagram of routing a communication and updating a user profile, in accordance with embodiments of the disclosure.

FIG. 4 depicts a flow diagram of an example method for routing an incoming communication and updating a user profile based on end user data, in accordance with some embodiments of the disclosure.

FIG. 5 is a block diagram illustrating an exemplary computer system, in accordance with some embodiments of the disclosure.

### DETAILED DESCRIPTION

A communication services platform, such as a Software as a Service (SaaS) platform, can offer various communication services to users. For example, a SaaS platform can offer messaging service tools that facilitate messaging conversations, e.g., the sending and/or receiving of messages, such as SMS messages, MMS messages, and/or IM messages, to and from devices via various communication channels. A communication channel can refer to a form of communication that uses one or more of a particular protocol, a particular underlying technology or is provided by a particular entity (e.g., third-party entity). Different communication channels can refer to different forms of communication that can use one or more of different communication protocols, different underlying technologies (e.g., SMS vs IP), or are provided by different entities, such as a third-party entity, that offer services, software or hardware (or a combination thereof) through which messages can be exchanged between recipient devices. For instance, the SaaS platform may send a text message (e.g., SMS message) to a recipient device using a communication channel, such as a telecommunications carrier network or send an instant message to a recipient device using an IM communication channel (e.g., using an application programming interface (API) to communicate with the IM communication channel). Examples of channels can include Public Switched Telephone Network (PSTN) based channels such as SMS or MMS, Internet Protocol (IP) based channels, and proprietary channels (e.g., proprietary social media messaging applications).

A SaaS platform can also offer communication services such as voice services that include routing inbound and outbound voice calls. In addition to routing voice calls, voice services and/or communication services generally can include transcription services, conference call services, recording services, interactive voice recognition (IVR) services, text-to-speech services, virtual artificial intelligence (AI) assistant services, human agent services, among others. For instance, the SaaS platform can provision telephone numbers to an organization (e.g., entity) and the provisioned telephone numbers can be assigned, often dynamically, to various user accounts of the organization. The organization may, via APIs, configure user-defined routing logic that can specify rules detailing how the SaaS platform is to route particular voice calls and/or execute particular voice services before, during, and/or after the voice calls.

Clients of a SaaS platform may subscribe to one or more voice services that allow the clients, via client devices, to receive inbound voice calls from customers (e.g., customers of the client) and place outbound voice calls to customers. The inbound and outbound voice calls can be orchestrated by the SaaS platform such that to establish the voice call between the client device and customer device a connection between the SaaS platform and the customer device is established and a connection between the SaaS platform and the client device is also established.

With the numerous communication services offered by the SaaS platform, clients desire the tools and infrastructure to customize the various communication services and to coordinate and customize the routing of incoming communications for specific end users. Coordinating, customizing and routing communication services that are customized to a particular end user can be challenging at least because end user data pertaining to a specific end user may not be readily available or outdated, and the complexity of the communication services and routing of incoming communications can be high, especially in view of the numerous customizable and customized features implemented by an organization.

Aspects of the disclosure address the above-mentioned and other challenges by implementing tools that allow a client organization to specify user-defined conditions and/or rules to route an incoming communication, such as an incoming voice call, to a communication service among multiple communication services.

In some embodiments, the SaaS platform can query one or more client databases (using third-party application programming interface (API) calls) to obtain end user data to create one or more user profiles (e.g., end user profiles). In some embodiments, the queries can be time-based (e.g., periodic) or event-based to keep the user profile up to date. For example, the user profile can include end user data identifying demographic information of the end user, identify interactions the end user has had with the client organization and/or SaaS platform, as well as other information. In some embodiments, the SaaS platform can implement a low-code or no-code environment that allows client organizations to customize end user data collections, communication services and/or routing logic (e.g., routing conditions) to route incoming communications.

In some embodiments, an incoming communication directed to the client organization can be received by the SaaS platform. For example, the SaaS platform can provision one or more telephone numbers to a client organization. Incoming voice calls directed to the provisioned telephone numbers can be initially connected to the SaaS platform before being routed to a client device of the client organization. Once the incoming communication is received, the SaaS platform can identify relevant end user data pertaining to the caller (e.g. end user). For example, the incoming voice call can be associated with a telephone number of the caller device (e.g., end user device), and the telephone number can be used as a key to identify the corresponding user profile and the associated end user data. In some embodiments, the relevant end user data can be retrieved based on user-specified conditions indicating the specific end user data to retrieve from the user profile.

In some embodiments, the relevant end user data is evaluated against user-defined routing conditions to determine, among multiple communication services, a communication service to route the incoming communication. For example, the relevant end user data can include the number of times the end user has called the client organization in the past 7 days. The routing conditions can include a condition that specifies that an incoming voice call be routed to an interactive voice response (IVR) application unless the end user has called more than three times in the last 7 days. If the end user has called more than three times in the last 7 days, the end user is to be routed to a human agent service to speak to a human agent. If the end user has called more than three times in the last 24 hours, the end user is moved to the front of the queue of the human agent service.

In some embodiments, the end user device is routed to the identified communication service where the particular communication service is further customized based on user-defined communication service conditions. For example, the incoming voice call can be routed to an IVR application. End user data can also be sent to the IVR application. The IVR dialog flow can be adjusted based on the end user data and/or IVR logic. For example, the IVR dialog, upon receipt of the incoming voice call, can ask the end user whether they are calling about an earlier issue identified by the end user data. In some embodiments, the incoming communication can be transferred or routed among communication services based on user-defined conditions. For example, the IVR application can transfer the voice call to a human agent service based on an end user response or command.

In some embodiments, the incoming communication can be used to update the end user data of the user profile. The updated user profile can be used to more precisely address and/or route subsequent incoming communications. In some embodiments and for example, the communication service can send to the SaaS platform a voice call summary or transcript. The summary and/or transcript can be stored as end user data with the user profile. In some embodiments, the SaaS platform can perform sentiment analysis to determine the sentiment associated with the communication. An indicator of the sentiment of the communication can be stored as end user data with the user profile. In some embodiments the SaaS platform can generate a calculated metric pertaining to the communication and store the calculated metric with the end user data of the user profile. For example, the SaaS platform can calculate the number of voice calls received from the telephone number of the end user device in the last 7 days.

As noted, a technical problem addressed by some embodiments of the disclosure is the coordinating, customizing and/or routing to communication services.

A technical solution to the above-identified technical problem(s) may include providing tools to route an incoming communication, such as a voice call, to a communication service using user-defined conditions and/or tools to update user profiles associated with the routing of incoming communications.

Thus, the technical effect may include routing an incoming communication, such as a voice call, to a communication service using user-defined conditions and/or updating user profiles associated with the routing of incoming communications.

It can be appreciated that aspects of the disclosure are described as pertaining to voice calls for the purpose of illustration, rather than limitation. In some embodiments, the aspects of the disclosure can be applied to other areas including, but not limited to other communication services of the SaaS platform.

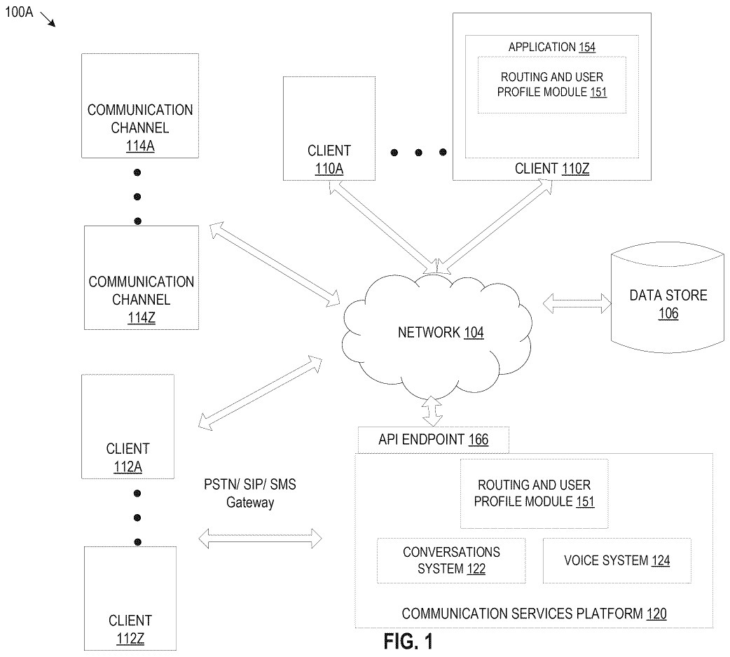

FIG. 1 illustrates an example system architecture 100A, in accordance with some embodiments of the disclosure. The system architecture 100A (also referred to as “system” herein) includes a communication services platform 120, a data store 106, client devices 110A-110Z connected to a network 104, client devices 112A-112Z communicatively coupled to communication services platform 120, and communication channels 114A-114Z coupled to the network 104 (or otherwise communicatively coupled to other elements of the system 100A).

In embodiments, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, data store 106 is a persistent storage that is capable of storing data as well as data structures to tag, organize, and index the data. Data store 106 may be hosted by one or more storage devices, such as main memory, magnetic or optical storage-based disks, tapes or hard drives, NAS, SAN, and so forth. In some embodiments, data store 106 may be a network-attached file server, while in other embodiments data store 106 may be some other type of persistent storage such as an object-oriented database, a relational database, and so forth, that may be hosted by communication services platform 120 or one or more different machines coupled to the communication services platform 120 via the network 104.

The client devices 110A-110Z (generally referred to as “client device(s) 110” herein) may each include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some embodiments, client devices 110 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some embodiments, client devices 110A through 110Z may also be referred to as “user devices.”

In some embodiments, a client device, such as client device 110Z, can implement or include one or more applications, such as application 154 (also referred to as “client application 154” herein) executed at client device 110Z. In some embodiments, application 154 can be used to communicate (e.g., send and receive information) with communication services platform 120. In some embodiments, application 154 can implement user interfaces (e.g., graphical user interfaces (GUIs)) that may be webpages rendered by a web browser and displayed on the client device 110Z in a web browser window. In another embodiment, the user interfaces of client application 154 may be included in a stand-alone application downloaded to the client device 110Z and natively running on the client device 110Z (also referred to as a “native application” or “native client application” herein).

In some embodiments, client devices 110 can communicate with communication services platform 120 using one or more function calls, such as application programming interface (API) function calls (also referred to as “API calls” herein). For example, the one or more function calls can be identified in a request using one or more application layer protocols, such a HyperText Transfer Protocol (HTTP) (or HTTP secure (HTTPS)), and that are sent to the communication services platform 120 from the client device 110Z implementing application 154. In some embodiments, the communication services platform 120 can respond to the requests from the client device 110Z by using one or more API responses using an application layer protocol. Similarly, communication services platform 120 can communicate with one or more communication channels 114A-114Z using API function calls.

In some embodiments, one or more of client devices 110 can be identified by a uniform resource identifier (URI), such as a uniform resource locator (URL). For example, communication services platform 120 can send an API call to client device 110Z addressed to a URL specific to the client device 110Z. In some embodiments, the communication services platform 120 can be identified by a URI. For instance, the API call sent by a client device 110 to communication services platform 120 can be directed to the URL of communication services platform 120.

In some embodiments, the APIs used to access the conversations system 122 of the communication services platform 120 can be different from the APIs used to access the voice system 124 of communication services platform 120. In some embodiments, the APIs used by application 154 executed on a desktop client device (e.g., desktop application) to access the voice system 124 can be different APIs than the APIs used by application 154 executed on a mobile client device (e.g., mobile application) to access the voice system 124. In some embodiments, conversations system 122 and voice system 124 can communicate between one another using APIs. In some embodiments, the APIs used to communicate between conversations system 122 and voice system 124 may be private APIs that are not accessible by client devices 110 (or client devices 112).

In some embodiments, client devices 112A-112Z (generally referred to as “client device(s) 112” herein) may be similar to client devices 110. In some embodiments, client devices 112 can include one or more telephony devices. A telephony device can include a Public Switched Telephone Network (PSTN)-connected device, such as a landline phone, cellular phone, or satellite phone, for example. In some embodiments, a telephony device can also include an internet addressable voice device (e.g., non-PSTN telephony device), such as Voice-Over-Internet-Protocol (VOIP) phones, or Session Initiation Protocol (SIP) devices, for example. In some embodiments, a telephony device can include one or more messaging devices, such as a Short Message Service (SMS) network device that, for example, uses a cellular service to exchange SMS messages or Multimedia Messaging Service (MMS) messages.

In some embodiments, the communication services platform 120 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that may be used to provide a user with access to data or services. Such computing devices may be positioned in a single location or may be distributed among many different geographical locations. For example, communication services platform 120 may include a plurality of computing devices that together may comprise a hosted computing resource, a grid computing resource or any other distributed computing arrangement. In some embodiments, communication services platform 120 may correspond to an elastic computing resource where the allotted capacity of processing, network, storage, or other computing-related resources may vary over time.

In some embodiments, communication services platform 120 provides one or more API endpoints 166 that can expose services, functionality or content of the communication services platform 120 to one or more of client devices 110 or communication channels 114A-114Z. In some embodiments, an API endpoint 166 can be one end of a communication channel, where the other end can be another system, such as a client device 110Z or communication channel 114Z. In some embodiments, the API endpoint 166 can include or be accessed using a resource locator, such a universal resource locator (URL), of a server or service. The API endpoint 166 can receive requests from other systems, and in some cases, return a response with information responsive to the request. In some embodiments, HTTP or HTTPS methods can be used to communicate to and from API endpoint 166.

In some embodiments, the API endpoint 166 (also referred to as a “request interface” herein) can function as a computer interface through which communication requests, such as message and/or voice requests, are received and/or created. The communication services platform 120 may include one or more types of API endpoints.

In some embodiments, the API endpoint 166 can include a messaging API and/or voice API whereby external entities or systems can send a communication to create message content and/or request sending of a message and/or request voice services that are provided via voice system 124. The API (e.g., message API and/or voice API) may be used in programmatically creating message content and/or requesting sending of one or more messages and/or requesting the transfer or joining client device(s) to a voice call. In some embodiments, the API is implemented in connection with a multitenant communication service wherein different accounts (e.g., authenticated entities) can submit independent requests. These requests made through the API can be managed with consideration of other requests made within an account and/or across multiple accounts on the communication service.

In some embodiments, the API of the API endpoint 166 may be used in initiating general messaging or communication requests. For example, a messaging request may indicate one or more destination endpoints (e.g., recipient phone numbers), message content (e.g., text and/or media content), and possibly an origin endpoint (e.g., a phone number to use as the “sending” phone number).

In some embodiments, the API of the API endpoint 166 may be any suitable type of API such as a REST (Representational State Transfer) API, a GraphQL API, a SOAP (Simple Object Access Protocol) API, and/or any suitable type of API. In some embodiments, the communication services platform 120 can expose through the API, a set of API resources which when addressed may be used for requesting different actions, inspecting state or data, and/or otherwise interacting with the communication platform.

In some embodiments, a REST API and/or another type of API may work according to an application layer request and response model. An application layer request and response model may use HTTP (Hypertext Transfer Protocol), HTTPS (Hypertext Transfer Protocol Secure), SPDY, or any suitable application layer protocol. Herein HTTP-based protocol is described for purposes of illustration rather than limitation. The disclosure should not be interpreted as being limited to the HTTP protocol. HTTP requests (or any suitable request communication) to the communication services platform 120 may observe the principles of a RESTful design or the protocol of the type of API. RESTful is understood in this document to describe a Representational State Transfer architecture. The RESTful HTTP requests may be stateless, thus each message communicated contains all necessary information for processing the request and generating a response. The API service can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

In some embodiments, the API endpoint 166 can include a request instruction module that can be called within an application, script, or other computer instruction execution. For example, a computing platform may support the execution of a set of program instructions where at least one instruction within a script or other application logic is used in specifying a message request and communicating that request.

In some embodiments, the API endpoint 166 can include a console, administrator interface, or other suitable type of user interface. Such a user-facing interface can be a graphical user interface. Such a user interface may additionally work in connection with a programmatic interface.

In some embodiments, a request, such as a message request, can include a data object characterizing the properties of a message. In some embodiments, the communication services platform 120 is associated with message requests that are programmatically initiated (e.g., an application-to-person (A2P) message). In some embodiments, the message request could be one initiated from an inbound received message.

In some embodiments, a request (e.g., message request and/or voice request) can include one or more of one or more destination endpoints, one or more origin endpoints, and message content and/or audio content. In some embodiments, one or more of these properties may be specified indirectly such as through system or account configuration or identifier (e.g., messaging conversation identifier). For example, all messages may be automatically assigned an origin endpoint that is associated with an account. In some embodiments, the message content can include any suitable type of media content including, text, audio, image data, video data, multimedia, interactive media, data, and/or any suitable type of message content.

In an illustrative example, used for illustration rather than limitation, communication services platform 120 can include a Software as a Service (SaaS) platform that can at least in part provide one or more services, such as communication services, to one or more clients. The SaaS platform may deploy services, such as software applications, to one or more clients for use as an on-demand service. For example, the SaaS platform may deliver and/or license software applications on a subscription basis while also hosting, at least in part, the software application. The licensed software applications can, at least in part, be hosted on the infrastructure, such as the cloud computing resources of the SaaS platform.

In some embodiments, communication services platform 120, as noted above, can provide communication services that include, but are not limited to, voice services, messaging services (e.g., SMS services, MMS services, rich business messaging (RBM) services, or rich communication services (RCS)), email services, video services, chat messaging services (e.g., internet-based chat messaging services), virtual artificial intelligence (AI) assistant services, human agent services, or a combination thereof. Communication operations using the communication services can use one or more of a communication network (e.g., Internet), telecommunications network (e.g., such as a cellular network, satellite communication network, or landline communication network), or a combination thereof, to transfer communication data between parties.

In some embodiments, the conversations system 122 can function to interface with one or more communication network(s) and/or service(s) for communication of a conversation (e.g., a messaging conversation, such as SMS, MMS, and/or chat messaging). In some embodiments, the conversations system 122 can include an interface to one or more carrier-based communication routes used in sending SMS, MMS, and/or other carrier-based messages. There may be multiple carrier-based communication routes that serve as different optional “routes” when sending communications over a carrier-based network (e.g., a mobile network). The conversations system 122 may additionally or alternatively include an interface to one or more over-the-top (OTT) communication channels which may be offered by a third-party messaging platform (e.g., proprietary social media messaging, messaging applications, etc.).

Routing can refer to directing or managing the path that data, voice calls, or other communications take through a network or system. A route can refer to a communication delivery path, and in some cases is defined by a series of one or more of computers, routers, gateways and/or carrier networks through which the communication is transferred from a source computer to a destination computer (e.g., through which the transmission of a message occurs). For example, the same route may be used to transfer messages using different communication channels, and the same communication channel may be used to transfer messages using different routes. In some example embodiments, different channels correspond to different applications on a receiving device. For example, a smart phone may have one application to handle SMS messages, another application to handle email, and a third application to handle voicemail. Alternatively, some applications may handle multiple communication channels. For example, one application may handle both SMS and MMS messages.

In some embodiments, when the conversations system 122 elects to send a message using a carrier-based channel, the message is communicated to an appropriate carrier connection for routing to the destination endpoint. Carrier-based channels can use SMPP (Short Message Peer-to-Peer protocol) for communicating to an aggregator or another suitable gateway such that the SMS/MMS message is transferred over a carrier network. Once transmitted to the carrier network, the message can be relayed appropriately to arrive at the intended destination. A message in transit may have multiple routing segments that are used in the delivery to an end destination device.

For example, the conversations system 122 can include an interface to one or more SMS Gateways that enable a computer to send and receive SMS text messages to and from a SMS capable device over the global telecommunications network (normally to a mobile phone). The SMS Gateway translates the message sent and makes it compatible for delivery over the network to be able to reach the recipient. The different SMS gateways (or more generally message gateways) can serve as different route options when the conversations system 122 is determining a channel and/or route to be used for one or more message transmissions.

In some embodiments, SMS Gateways can route SMS text messages to the telco networks via an SMPP interface that networks expose, either directly or via an aggregator that sells messages to multiple networks. SMPP, or Short Message Peer-to-Peer, is a protocol for exchanging SMS messages between Short Message Service Centers (SMSCs) and/or External Short Messaging Entities (ESMEs).

In some embodiments, the destination of a message may be used in determining the candidate message routes (and/or channels). For example, a phone number of a destination endpoint or another identifier associated with the intended recipient of the message may be used to identify the destination network of the intended recipient. Each destination network may be assigned a Mobile Country Code (MCC)/Mobile Network Code (MNC) pair that identifies the specific destination network.

In some embodiments, communication services platform 120 includes a conversations system 122 that can use the phone number associated with the intended recipient of the message to lookup the MCC/MCN pair identifying the destination network. For example, the conversations system 122 can determine the MCC/MNC pair using an MCC/MNC directory that lists the MCC/MNC pair corresponding to each phone number. In some embodiments, the MCC/MNC directory may be stored in a routing provider storage. Alternatively, the MCC/MNC directory may be stored at some other network accessible location. In either case, the conversations system 122 can use the phone number associated with the intended recipient of the message to query the MCC/MNC directory and identify the MCC/MNC pair that identify the corresponding destination network.

In some embodiments, the conversations system 122 can use the MCC/MNC pair retrieved from the MCC/MNC directory to identify candidate routing providers and routes that are available to deliver a message to the destination network identified by MCC/MNC pair. For example, the routing provider storage may include a routing provider directory that lists each MCC/MNC pair serviced by the conversations system 122 and the corresponding routing providers and routes available for use with each MCC/MNC pair. That is, the routing provider directory can list the routing providers and routes that are available to the conversations system 122 to deliver messages to the destination network identified by each MCC/MNC pair listed in the routing provider directory.

In some embodiments, voice system 124 of communication services platform 120 can enable the placement of an outbound voice call and/or routing of an inbound voice call. A voice call (also referred to as a “call” herein) can refer to a telephone call between at least two user devices to communicate two-way voice data (e.g., voice sound) in real-time. An outbound voice call can refer to a voice call from a client device 110 associated with an account (e.g., one or more of an organization's account or user account) of the communication services platform 120, and to another device that may not be associated with an account. An inbound voice call can refer to a voice call from a device that may not be associated with an account, and to a client device 110 associated with an account. It can be appreciated that a voice call between two client devices 110 that are associated with an account can be performed using communication services platform 120. Such voice calls can be considered inbound or outbound voice calls relative to the particular client device 110.

In some embodiments, voice system 124 can include one or more voice services (e.g., communication service(s)) used in conjunction with a voice call. In some embodiments, the one or more voice services can include a transcription service that transcribes speech to text. In some embodiments, the one or more voice services can include a recording service that can record the audio data of the voice call. In some embodiments, the one or more voice services can include a voice call queue service that can queue inbound voice calls and release the queued voice call pursuant to user-defined logic. In some embodiments, the one or more voice services can include voice mailbox services that store voice messages of at least inbound calls. In some embodiments, the one or more voice services can include an interactive voice response (IVR) service that interacts with callers and gathers information for them by giving the callers choices via a menu, and then performs the actions based on the answers of the caller through the telephone keypad or through voice response. For example, the IVR service can allow a caller to interact with the back-end telephony system, such as voice system 124, by pressing keys that emit dual-tone multi-frequency (DTMF) signals or saying words that are processed by a speech recognition system. In some embodiments, the one or more voice services can include a conference call service that can connect three or more devices in a single call.

In some embodiments, conversations system 122 and/or voice system 124 can include a communication service such as a human agent services that facilitates communication with a live agent. In some embodiments, the communication service can include a virtual AI assistant application. A virtual AI assistant can refer to a software application that uses artificial intelligence (AI) technologies, such as a generative AI model, to perform tasks and provide services for users. The tasks can range from simple administrative functions, like setting reminders and sending messages, to more complex activities, such as providing customer support, helping users manage services or engaging in natural language conversations. In some embodiments, a virtual AI assistant can simulate human-like interactions and perform tasks through natural language processing (NLP) and machine learning algorithms. The virtual AI assistant can function as an intelligent intermediary, capable of understanding, interpreting, and responding to user inputs via text or voice. In some embodiments, the virtual AI assistant can leverage one or more large language models (LLMs) and/or advanced neural network architectures to process complex queries, generate contextually relevant responses, and/or execute commands across various platforms and devices. In some embodiments, the virtual AI assistant can integrate with APIs and databases to retrieve and manipulate data, providing functionalities such as scheduling, information retrieval, and task automation.

In some embodiments, communication services platform 120 can include a multitenant system. Multitenancy can refer to a mode of operation of software applications where multiple independent instances of one or multiple applications operate in a shared computer environment. In some embodiments, the instances (tenants) can be logically isolated, but physically integrated. The degree of logical isolation can be complete, but the degree of physical integration can vary. The tenants (application instances) can be representations of organizations that obtain access to the multitenant system. The tenants may also be multiple applications competing for shared underlying resources. Multiple organizations can access the resources of communication services platform 120 without any indication that the resources are shared between the multiple organizations. The data of each of the organizations can be logically isolated from one another such that each organization has access to their own data but not the data of other organizations in the multitenant system. In some embodiments, communication services platform 120 can include a single tenant system.

An organization can be an example of an entity, such as a legal entity, which includes multiple people and that has a particular purpose. A non-limiting example of an organization includes a corporation (e.g., authorized by law to act as a single entity or legal entity). In some embodiments, multiple organizations can include one or more organizations that are independent or distinct from the other organizations. For example, a first organization can be corporation A and a second organization can be corporation B. Corporation A can be considered an independent legal entity from corporation B. Each of corporation A and corporation B can make independent decisions and have a different legal or corporate structure.

In some embodiments, a “user” may be represented as a single individual. However, other embodiments of the disclosure encompass a “user” being an entity controlled by a set of users and/or an automated source. For example, a set of individual users federated as one or more departments in an organization may be considered a “user.” In general, functions described in one embodiment as being performed by the communication services platform 120 can also be performed on the client devices 110A through 110Z in other embodiments (and vice versa), if appropriate. In addition, the functionality attributed to a particular component can be performed by different or multiple components operating together. The communication services platform 120 can also be accessed as a service provided to other systems or devices through appropriate APIs.

As noted above and in some embodiments, a communication channel can refer to an entity, such as a third-party entity (e.g., organizations different from communication services platform 120), that offers services, software or hardware (or a combination thereof) through which messages can be sent to recipient devices. (e.g., organizations different from communication services platform 120). A third party can refer to an entity, such as organization or business (e.g., a different legal entity than communication services platform 120) that is distinct from and/or external to another entity (such as a first-party entity), such as the entity controlling or owning the communication services platform 120. For example, a third-party database is not controlled by a first party but may be accessed by the first party upon authorization by the third-party. In some embodiments, the communication services offered by communication channels 114A-114Z can be integrated into communication services platform 120. In some embodiments, the communication services offered by communication channels 114A-114Z can include messaging services. In some embodiments, messaging services can include one or more of a short messaging service (SMS) offered by an SMS channel, a multimedia messaging service (MMS) offered by an MMS channel, rich business messaging (RBM) offered by an RBM channel, or rich communication services (RCS) offered by an RCS channel or an instant messaging service (e.g., chat messaging) offered by an instant messaging service channel. In some embodiments, communication channels 114A-114Z can also include a voice channel. For example, the voice channel may implement an application to send or receive calls. In another example, the voice channel may include a telecommunication service provider and/or PSTN voice services. In some embodiments, the messaging services can include an electronic mail (email) service offered by an email channel.

In some embodiments, an instant messaging service is different from an electronic mail (email) service. In some embodiments, the communication channels 114A-114Z can include an email channel. In some embodiments, the communication channels 114A-114Z exclude an email channel. In some embodiments, email messages can use a standard protocol for sending and receiving email messages. The standard protocol can be used across different platforms. In some embodiments, instant messages can use protocols specific to a platform that may or may not be compatible with other platforms. In some embodiments, instant messaging can differ from email in that conversations over instant messaging can happen in real-time, while conversations over email are not in real-time.

In some embodiments, communication services platform 120 and/or client devices 110 include an instance of virtual routing and user profile module 151. In some embodiments, routing and user profile module 151of client device 110Z, of communication services platform 120, or a combination thereof can perform one or more aspects or embodiments of the disclosure.

In some embodiments, an entity (e.g., organization) can be associated with an account (e.g., organizational account) of communication services platform 120. Within the particular account (e.g., organizational account) of the organization, one or more user accounts of the communication services platform 120 may be associated with different users of the organization. In some embodiments, the accounts are organized in a hierarchical structure where the organizational account is the root at the top of the hierarchy and the user accounts are nested under the organizational account.

In some embodiments, communication services platform 120 can provision telephone numbers (e.g., 10-digit long code or short code) to an organization's account and assign the telephone numbers to various user accounts associated with the organization. The assignment of telephone numbers can be flexible such that the assignment of a telephone number can be one to one (e.g., one telephone number to one user account) or one to many (e.g., one telephone number to many user accounts).

In some embodiments, communication services platform 120 can dynamically assign or transfer the telephone numbers. For example, user account A may be assigned telephone number A. Telephone number A can be transferred and assigned to another user account Z and unassigned from user account A, or can be assigned to user account Z and user account A, for instance.

In some embodiments, voice calls and messages can be dynamically routed or sent to and from different telephone numbers. For instance, a user account A may be assigned telephone number A. Telephone number A may have an area code corresponding to Texas. User account A, via application 154 of client device 110A, sends, via communication services platform 120, a message A to an end user device. The end user device can be associated with a telephone number with an area code associated with the state of California. Communication services platform 120 can associate a telephone number with a California area code to the message conversation and send message A to end user device from the associated telephone number with a California area code. From the perspective of the end user device, the message A can appear to be sent from the telephone number with a California area code, rather than from the telephone number A with a Texas area code.

In some embodiments, the telephone number of the client device 110 (e.g., telephone number assigned to the client device 110 by the telecommunications carrier) can be different than the telephone number that is assigned to the user account associated with the client device 110. In some embodiments, the client device 110 may not have a telephone number assigned by a telecommunications carrier. For instance, the client device 110A may be a desktop computer. In some embodiments, the client device 110A can be identified by an internet protocol (IP) address and can send messages of the message conversation using a protocol such as HTTP over TCP/IP (transmission control protocol) or can place a voice call using a Voice over IP (VoIP) protocol (e.g. SIP) via application 154, for example.

Although embodiments of the disclosure are discussed in terms of communication service platforms, embodiments may also be generally applied to any type of platform, system or service.

In situations in which the systems discussed here collect personal information about users, or may make use of personal information, the users may be provided with an opportunity to control whether the communication services platform 120 collects user information, or to control whether and/or how to receive content from the communication services platform 120 that may be more relevant to the user. In addition, certain data may be treated in one or more ways before it is stored or used, so that personally identifiable information is removed. For example, a user's identity may be treated so that no personally identifiable information can be determined for the user generalized where location information is obtained (such as to a city, ZIP code, or state level), so that a particular location of a user cannot be determined. Thus, the user may have control over how information is collected about the user and used by the communication services platform 120.

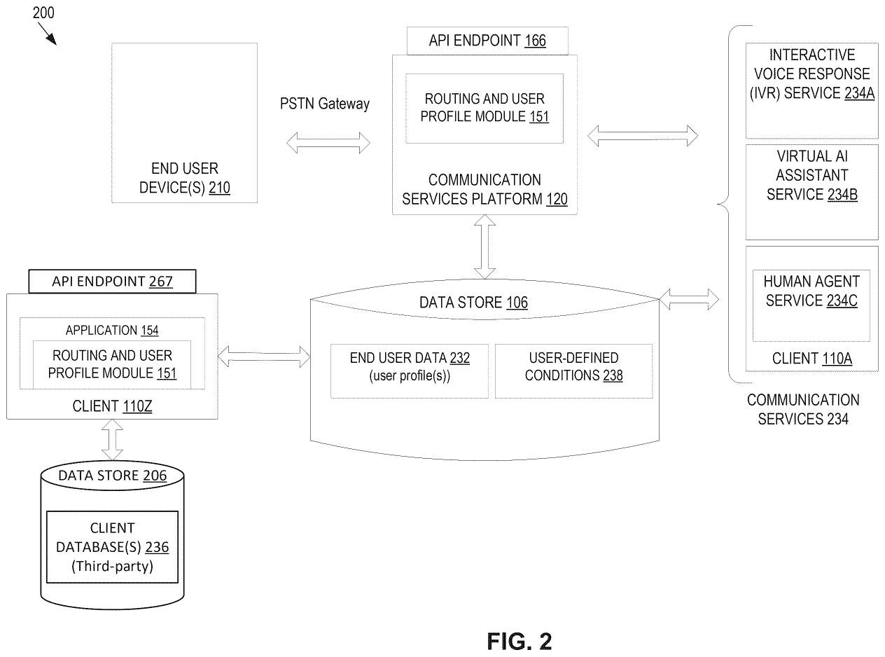

FIG. 2 illustrates an example system architecture used for routing a communication and updating a user profile, in accordance with some embodiments of the disclosure.

Components of FIG. 1 are used to help describe aspects of FIG. 2. The system architecture 200 (also referred to as “system” herein) includes a communication services platform 120, a data store 106, data store 206, one or more client devices 110A through 110Z, end user device(s) 210 and communication services 234. In some embodiments, routing and user profile module 151 can perform one or more of the operations described with respect to communication services platform 120. In some embodiments, routing and user profile module 151 can perform one or more of the operations described with respect to client device 110Z.

The description with respect to data store 106 can apply to data store 206, unless otherwise described. The description with respect to client device 110 can apply to end user device(s) 210, unless otherwise described. The description with respect to API endpoint 166 can apply to API endpoint 267, unless otherwise described.

Communication services 234 can include one or more communication services, such as one or more IVR services 234A, one or more virtual AI assistant services 234B, and/or one or more human agent services 234C. In some embodiments, the IVR services 234A, virtual AI assistant services 234B, and/or human agent services 234C can be or include first-party services, third-party services, or a combination thereof. In some embodiments, for third-party services a third-party API can be used by the communication services platform 120 and or client organization (e.g., via client device 110Z) to communicate with and/or customize the third-party service. It some embodiments, for first-party services the client organization (e.g., via client device 110Z) can communicate with and/or customize the first-party service using first-party API calls.

In some embodiments, the IVR service can include a pre-configured or user-programmable IVR service. In some embodiments, a user-programmable IVR service can include a cloud-based platform that allows developers to build conversational interfaces for voice-based and/or text-based applications. In some embodiments, the IVR service (both user-programmable and pre-configured) can use natural language processing (NLP) and/or machine learning to interpret and respond to end user inputs through voice and/or text interactions. In some embodiments, developers can design complex dialog flows by defining one or more of intents (end user's purpose), entities (specific data extracted from the end user's input), and fulfillment mechanisms (backend actions such as database queries or API calls). In some embodiments, the user-programmable IVR service can provide tools for managing contexts, which maintain conversational state, and supports integration with various communication channels like phone systems, messaging applications, and/or web interfaces. In some embodiments and as further described below, the IVR can be configured using one or more user-defined conditions (e.g., IVR conditions) using one or more API calls. The user-defined conditions can be used to customize the IVR experience and define one or more of dialog flows, intents, entities and/or fulfillment mechanisms.

In some embodiments, the virtual AI assistant service 234B can provide one or more virtual AI assistants. A virtual AI assistant can refer to a software application that uses artificial intelligence (AI) technologies, such as a generative AI model and/or natural language processing (NLP), to perform tasks and provide services for users. The tasks can range from simple administrative functions, like setting reminders and sending messages, to more complex activities, such as providing customer support, helping users manage services or engaging in natural language conversations. In some embodiments, the virtual AI assistant can interact with an end user through text or voice commands (e.g., in natural language) to perform various tasks. With respect to voice calls, the virtual AI assistant can make, receive, and/or manage voice calls on behalf of the end user, in some embodiments. In some embodiments, the virtual AI assistant can conduct or implement conversational behavior with the end user. In some embodiments, the virtual AI assistant can perform actions such as dialing numbers, answering calls, transcribing voicemails, screening calls, providing caller information, setting up call reminders, and even holding or transferring calls. In some embodiments, virtual AI assistant can understand the context and/or intent of the conversation, enabling the virtual AI assistant to respond to queries, schedule appointments, provide directions, and/or interact with other connected applications and services.

In some embodiments, communication services 234 can include a human agent service 234C. In some embodiments, a human agent service 234C can include one or more human agents that can communicate with the end user. The human agent can use one or more types of communication, such as a voice call, text message, or text chat to communicate with the end user. The communication between the end user and human agent can be facilitated by the communication services platform 120, the end user device 210, and client device 110A. In some embodiments, the human agent is part of the client organization. In other embodiments, the human agent can be a third-party agent that is external to the client organization. In an example, the human agent can be one or many human agents of a call center. A voice call can be routed to the call center where a human agent can receive that voice call from the end user using the end user device 210.

As illustrated, client device(s) 110Z can communicate with communication services platform 120 using application 154. In some embodiments, instances of application 154 are provided by communication services platform 120 to client device(s) 110Z to facilitate transmission of end user data between one or more of client devices 110Z and communication services platform 120.

In an illustrative example and in some embodiments, users of client devices 110 can be part of an organization that uses one or more communication services provided by communication services platform 120. The users of the client devices 110 can each be assigned a user account (e.g., unique user account) that is associated with the organization and that allows access to the communication services provided by communication services platform 120. The organization may use the communication services platform 120 to facilitate communications, such as messaging conversations and/or voice calls with end users (e.g., customers of the organization and represented by end user device 210). For instance, client device 110A, via an application, can conduct a text messaging conversation and/or a voice call with an end user (e.g., end user device 210). End user can also be referred to as “customer” herein.

In some embodiments, communication services platform 120 generates and updates user profiles that reflect information pertaining to end users (e.g., end user data 232). Communication services platform 120 can use end user data to generate user profiles that each correspond to an end user and/or are associated with an identifier. For example, the end user profile can be associated with a particular telephone number of an end user device (e.g., end user device 210) and include information pertaining to the corresponding end user. End user data can refer to information that is associated with, pertains to, and/or describes an end user. For example, end user data can include an identifier (e.g., name, associated number, telephone number, etc.), communication history with the organization, pertain to communications using the communication services platform 120, purchase history, or other information corresponding to the end user. The user profiles can be generated and updated based on information received (over time) from one or more data sources, such as from the client organization and/or communications with communication services platform 120. In some embodiments, the user profiles are generated (and sometimes updated) prior to or asynchronously to receiving a communication, such as an incoming voice call from an end user device.

In some embodiments, communication services platform 120 can determine location data (e.g., location of the end user device 210) or signal data related to a communication (e.g., voice call). The location data and/or signal data can be used as a fingerprint indicative of call quality and/or network quality. The fingerprint can be stored in the end user profile, in some embodiments. In some embodiments, can use the fingerprint to determine when or how to handle the communication to and from an end user device 210.

In some embodiments, communication services platform 120 (e.g., first party) can send requests to client device 110Z to retrieve end user data associated with various end users. In some embodiments, the requests can be a time-based request (e.g., periodically) and/or an event-based request. In some embodiments, the requests for end user data can be user-configured. For example, the client organization can configure conditions (e.g., end user request conditions) indicating when or under what conditions end user data requests are to be sent and/or what end user data is to be requested. In some embodiments, the communication services platform 120 can use API calls, such as third-party API calls of the client organization and sent to API endpoint 267, to query one or more client databases 236 for end user data. In some embodiments, the data store 206 is a third-party data store and/or includes one or more third-party databases 236. In some embodiments, the client organization, via client device 110Z or directly from data store 206 can respond to the requests with information identifying the requested end user data.

In other embodiments, the client organization can send end user data to communication services platform 120 without a request from communication services platform 120. For example, the client organization can use one or more API calls of the communication services platform 120 to send end user data (e.g., push communication) to communication services platform 120 on a periodic or event-triggered basis. In some embodiments, the end user data 232 is stored at data store 106 and used to generate one or more user profiles (e.g., end user data 232).

In some embodiments, subsequent to obtaining end user data 232 (or at least a portion thereof) and generating corresponding user profiles, an end user device 210 can send a communication, such as an incoming voice call, using an identifier such as a recipient phone number associated with the client organization and/or client device. In some embodiments, the voice call is sent via a PSTN gateway to the communication services platform 120. In some embodiments, the recipient phone number can be provisioned to the client organization by the communication services platform 120. In some embodiments, the client organization can define user-defined conditions, via the communication services platform 120, identifying how the incoming call is to be handled and/or routed.

In some embodiments, the communication services platform 120 can receive the communication and determine an identifier associated with the communication. For example, for a voice call, the identifier can include the telephone number of the end user device 210. For an email, the identifier can include the email address of the end user. In some embodiments, the identifier can be used to identify the corresponding end user data 232 that is associated with a particular user profile for the end user. For example, the caller telephone number can be used a key to retrieve the corresponding user profile. In some embodiments, the corresponding user profile can include end user data and the communication services platform 120 can identify a relevant portion of the end user data (e.g., subset of end user data). In some embodiments, the relevant portion of the end user data can be specified by the client organization, by for example, client device 110Z.

In some embodiments, prior to receiving a communication from end user device 210, client device 110Z can, via API calls (e.g., first-party API calls) to API endpoint 166, specify one or more conditions related to the handling and routing of a communication, such as a voice call. In some embodiments, client device 110Z can use a no-code or low-code interface that allows the client organization to define one or conditions related to the handling and routing of communications. The user-defined conditions 238 can be sent to communication services platform 120 and stored at data store 106. In some embodiments, one or more conditions can apply generally to all communications of a various type (e.g., all voice calls, all text messages, etc.). In some embodiments, one or more conditions can be more granular and apply to individual user profiles or a subset of user profiles and so forth.

In some embodiments, the one or more user-defined conditions (e.g., end user data conditions) for obtaining relevant end user data (e.g., responsive to an incoming communication) can specify, among multiple end user data items of a user profile, what subset of end user data (items) is to be retrieved. For example, the end user data condition(s) can indicate that for any incoming voice call that the retrieved end user data include the number of received voice calls from the corresponding telephone number within the last N number of days. In some embodiments, the relevant end user data is retrieved from data store 106 based on the one or more end user data conditions. The relevant end user data is provided to communication services platform 120 to determine which communication service to route the incoming communication.

In some embodiments, the one or more conditions to route the incoming communication can include one or more user-defined conditions (e.g., routing conditions).

Similar as described above and in some embodiments, client device 110Z can use API calls (e.g., first-party API calls) to specify one or more routing conditions to route the communication to various communication services 234. In some embodiments, the one or more routing conditions can be compared to or evaluated against the retrieved end user data (e.g., subset of end user data). For example, if the communication services platform 120 determines that the incoming voice call is the first communication from the end user device 210 in the last month, the communication services platform 120 can determine to route the voice call to the IVR service 234A. In another example, if the communication services platform 120 determines that the incoming voice call is the fourth voice call from the telephone number in the last 3 days, the communication services platform 120 based on one or more routing conditions (e.g., greater or equal to 3 voice calls in the last three days are routed to a human agent) can route the voice call to a human agent (e.g., human agent service 234C). In another example, if the communication services platform 120 determines that the incoming voice call is the fourth voice call from the telephone number in the last 3 days, the communication services platform 120 based on one or more routing conditions can place the voice call in the front of a queue of voice calls to be received by a human agent (e.g., human agent service 234C). In another example, the voice call can be initially routed to the IVR service 234A and based on end user input, the voice call be routed to the virtual AI assistant service 234B.

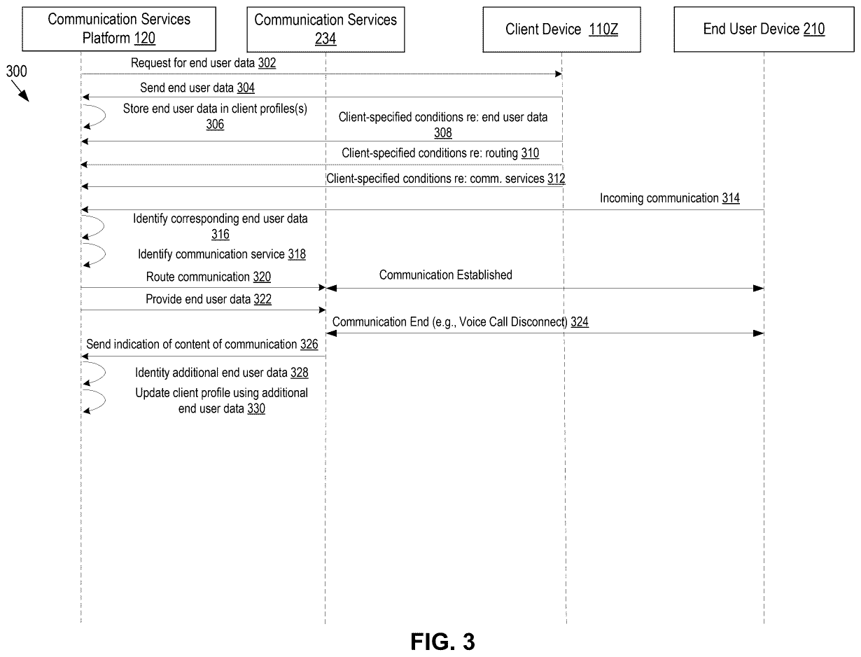

In some embodiments, one or more of the communications services 234 can be customized with user-defined conditions as further described with respect to FIG. 3.

In some embodiments, information pertaining to the communication (e.g., voice call) can be used as additional user data and sent to the communication services platform 120 to update the corresponding user profile (e.g., end user data 232). In some embodiments, the communication services platform 120 can identify additional end user data and update the client profile based on the additional end user data. The additional end user data that is retrieved and/or generated can be customized using one or more user-defined conditions (e.g., additional end user data conditions).

In some embodiments, the one or more communication service 234 to which the communication was routed can send an indication of the content of the communication to the communication services platform 120. For example, the particular communication service 234 can send the communication services platform 120 a transcript of the voice call, a transcript of the textual conversation or a summary of the conversation. In some embodiments, the communication services platform 120 can perform operations on the content of the communication between the end user and the particular communication service 234.

In some embodiments, the communication services platform 120 can perform sentiment analysis (e.g., sentiment analysis operation(s)) using the content of the communication to determine the sentiment of the communication. In some embodiments, an identifier of the determined sentiment of the communication can be stored as part of the user profile. In some embodiments, sentiment analysis of the communication can include using natural language processing (NLP) and/or machine learning techniques to identify and/or quantify the emotional tone expressed in the content. For text-based conversations, the process can include tokenization, stop-word removal, and applying models like transformers or recurrent neural networks to classify the sentiment as positive, negative, neutral, or more specific emotional categories (e.g., joy, anger, surprise, disgust, trust, anticipation, etc.). For voice calls, additional layers of analysis can be implemented, such as speech-to-text conversion and acoustic feature extraction, such as pitch, tone, and prosody, which can then be combined with textual analysis to provide a comprehensive assessment of the sentiment conveyed by both the words and the speaker's vocal characteristics.

In some embodiments, the communication services platform 120 can calculate a metric based on one or more of the indication of content of the communication or metadata corresponding to the communication and/or additional end user data. For example, the communication services platform 120 can determine that the voice call is the fourth communication from the end user device 210 in the last seven days. This calculated metric can be calculated based on original end user data and additional end user data and/or metadata pertaining to the voice call (e.g., time and date of the voice call). The calculated metric can be stored as part of the user profile associated with the telephone number.

Elements of FIG. 1 and FIG. 2 are used with respect to FIG. 3 to help describe features of diagram 300. The operations described with respect to FIG. 3 are shown to be performed serially for the sake of illustration, rather than limitation. Although shown in a particular sequence or order the order of the operations can be modified, unless otherwise specified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible. In some embodiments, the same, different, fewer, or greater operations can be performed.

FIG. 3 illustrates a sequence diagram of routing a communication and updating a user profile, in accordance with embodiments of the disclosure.

Diagram 300 illustrates communication services platform 120, communication services 234, client device 110Z, and end user device 210. In some embodiments, one or more of communication services platform 120, communication services 234, client device 110Z, and end user device 210, and in particular routing and user profile module 151 thereon can implement the operations depicted in diagram 300. In some embodiments, client device 110Z can represent a client device that corresponds to a user account associated with an administrator of an organization. Client device 110Z can implement routing and user profile module 151 using application 154.

At operation 302, communication services platform 120 sends one or more requests to client device 110Z for end user data pertaining to one or more user profiles. In some embodiments, communication services platform 120 used one or more third-party API calls to request end user data. In some embodiments, the requests can be to the same or different databases. For example, the communication services platform 120 can send requests to different databases to request end user data for a particular user profile. In some embodiments, the requests for end user data can be prior to communications received from an end user device 210. It can be appreciated that in some embodiments, the requests are to a client system, such as a client database system.

At operation 304, responsive to the one or more requests for end user data, client device 110Z sends end user data 304 to communication services platform 120.

At operation 306, communication services platform 120 stores the end user data in respective client profiles at, for example data store 106. In some embodiments, communication services platform 120 can store the raw data received from client device 110Z. In some embodiments, communication services platform 120 can perform operations (e.g., calculating metrics) using the end user data received from client device 110Z. The processed data (e.g., calculated metrics) can be stored as end user data in the user profile. As noted above, the creation and update of user profiles can be a continuous process where, for example, the user profiles are created and updated periodically or based on events. In some embodiments, the client device 110Z can perform a push operation (e.g., push communication) and send end user data to communication services platform 120 on a periodic or event-triggered basis.

At operation 308, client device 110Z can send to communication services platform 120 an indication of one or more conditions (e.g., end user data conditions) pertaining to end user data. For example, communication services platform 120 can proved to client device 110Z an application with an interface the allows the client to specify one or more conditions, such as end user data conditions, in a low-code or no-code environment. In some embodiments and noted above, the one or more user-defined conditions (e.g., end user data conditions) for obtaining end user data can specify, among multiple user data items of a user profile, what subset of end user data (items) is to be retrieved (e.g., what conditions or rules are to be used to retrieve end user data). In some embodiments, and as noted herein, the client device 110Z can use API calls (e.g., first-party API calls) to configure user-specified conditions.

At operation, 310, client device 110Z can send to communication services platform 120 an indication of one or more conditions (e.g., routing conditions) pertaining to the routing of communications to and/or from end user device 210. In some embodiments and as noted above, the conditions to route the incoming communication can include one or more user-defined conditions (e.g., routing conditions). In some embodiments, the routing conditions identify rules and/or conditions that specify for an incoming communication how a communication service is to be selected among multiple available communications services. In some embodiments, the end user data can be used in evaluating the routing conditions.

At operation 312, client device 110Z can sent to communication services platform 120 an indication of one or more conditions (e.g., communication service conditions) pertaining to one or more communications services. In some embodiments, the communication services platform 120 can provide an application interface that allows the client to configure one or more of the communication services. For example, the IVR service can be configured using one or more user-defined conditions (e.g., IVR conditions) using one or more API calls. The user-defined conditions can be used to customize the IVR experience and define one or more of dialog flows, intents, entities and/or fulfillment mechanisms.

In another example, the virtual AI assistant services can also be configured using one or more user-define conditions (e.g., virtual AI assistant conditions) using one or more API calls. The user-defined conditions can be used to customize the virtual AI assistant experience. For example, the virtual AI assistant can be used to personalize settings of the virtual AI assistant (e.g., customize voice, language, tone and/or personality traits), configure the virtual AI assistant to integrate with various applications or services, configure the virtual AI assistant to access relevant data (e.g., relevant end user data), configure the virtual AI assistant to handle data, such as personal information, and so forth.

In another example, the human agent service can be configured using one or more user-defined conditions (e.g., human agent conditions) using one or more API calls. The user-defined conditions can be used to customize the human agent service experience. For example, the human agent service can be customized to elevate or demote particular end users in a queue to a human agent. For example, the human agent service can receive information (e.g., end user data) that indicates that the end user has recently called (e.g., within 24 hours) and can elevate the end user voice call in a queue based on one or more user-specified conditions pertaining to the number and/or recency of voice calls from a same telephone number.

At operation 314, communication services platform 120 receives an incoming communication from end user device 210. In some embodiments, the incoming communication can be directed to a telephone number provisioned by the communication services platform 120. In some embodiments, the incoming communication can include an incoming voice call from end user device 210.

At operation 316, communication services platform 120 identifies the corresponding (e.g., relevant) end user data responsive to receiving an incoming communication directed to an identifier corresponding to a client organization. In some embodiments, the user profile associated with end user data corresponding to the end user can be associated with an identifier, such as a telephone number, corresponding to the end user and/or end user device 210. In some embodiments, communication services platform 120 can use the identifier associated with the incoming communication to perform a look up of the end user data associated with the corresponding user profile. In some embodiments, not all the end user data corresponding to a user profile is retrieved. In some embodiments, a subset of the end user data corresponding to a user profile is retrieved based on user-defined conditions and/or rules (e.g., end user data conditions).

At operation 318, communication services platform 120 can identify, among multiple communication services (e.g., routing options), the communication service to which the incoming communication is to be routed. In some embodiments, the communication services platform 120 can determine the multiple communication services by determining to which communication services the client organization is subscribed. In some embodiments, the client organization, via a client device 110, can configure one or more user-define conditions (e.g., routing conditions) that can be evaluated against the retrieved and relevant end user data to determine to which of the multiple communication services the incoming communication is to be routed. For example, a condition indicated that any profile having a sentiment analysis indicator as negative should be directed to a human agent service and placed in a higher priority queue.

At operation 320, communication services platform 120 routes the incoming communication to the identified communication service. In some embodiments, the communication is established between the communication service and end user device 210.

At operation 322, communication services platform 120 can provide the identified communication service with relevant end user data. In some embodiments, the relevant end user data can be or be part of the relevant end user data retrieved at operation 316. In some embodiments, the relevant end user data can be different from (at least in part) the end user data retrieved at operation 316. For example, responsive to determining the communication service to which the incoming communication is to be routed at operation 318, communication services platform 120 can identify additional end user data that can be used by the particular communication service. In some embodiments, the end user data of operation 322 can be provided as part of routing the communication in operation 320.

At operation 324, the communication between the end user device 210 and communication service(s) ends. For example, the end user can terminate the voice call.

At operation 326, the one or more communication services can send an indication of the content of the communication and/or information pertaining to the communication. For example, the communication service can send a transcript of the voice call. In another example, the communication service can send the duration and time of the voice call and/or other metadata corresponding to the voice call.

At operation 328, communication services platform 120 can identify additional end user data. In some embodiments, the additional end user data can correspond to the communication with the end user device 210. In some embodiments, the indication of the content of the communication and/or information pertaining to the communication can be stored with the corresponding user profile. In some embodiments, additional end user data can be created or generated based, in some instances on the information received from communication services 234. For example and in some embodiments, communication services platform 120 can calculate metrics pertaining to the communication and/or perform sentiment analysis on the communication. The calculated metric(s) and/or indicators of the result of the sentiment analysis can be the additional end user data. In some embodiments, the communication services 234 can calculate the additional end user data (e.g., calculated metric(s) and/or indicator(s) of the result of the sentiment analysis), which is sent to the communication services platform 120 at operation 326.

At operation 330, the communication services platform 120 can store the additional end user data in the corresponding client profile (e.g., update the client profile). In some embodiments, the updated client profile (e.g., the information contained therein) can be used for a subsequent communication from the end user device 210.

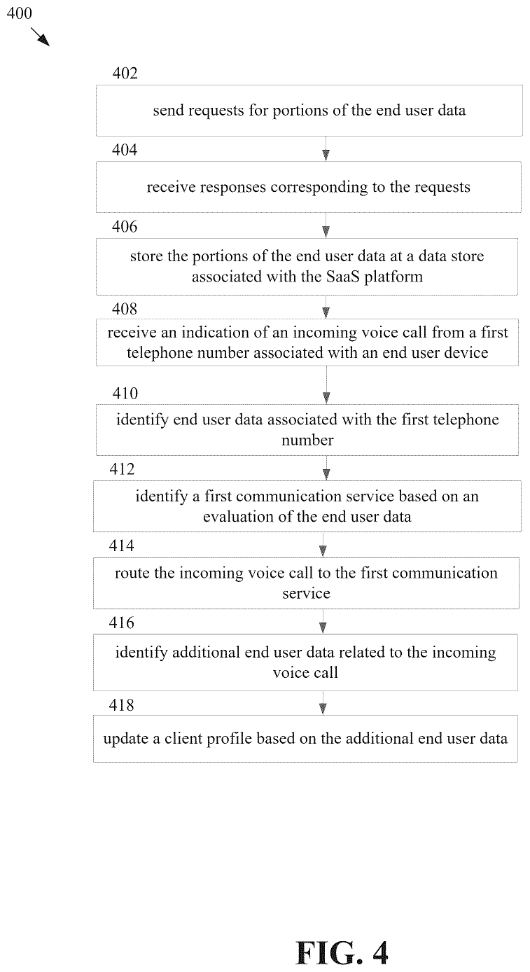

Method 400 of FIG. 4 and/or each of the aforementioned method's individual functions, routines, subroutines, or operations can be performed by a processing device, having one or more processing units (CPU) and memory devices communicatively coupled to the CPU(s). In some embodiments, the method 400 can be performed by a single processing thread or alternatively by two or more processing threads, each thread executing one or more individual functions, routines, subroutines, or operations of the method. Method 400 as described below can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 400 is performed by routing and user profile module 151 described in FIGS. 1 and 2. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible. In some embodiments, the same, different, fewer, or greater operations can be performed. It may be noted that elements of FIGS. 1-3 may be used herein to help describe FIG. 4.

FIG. 4 depicts a flow diagram of an example method 400 for routing an incoming communication and updating a user profile based on end user data, in accordance with some embodiments of the disclosure. In some embodiments, method 400 can be performed by communication services platform 120, and in particular routing and user profile module 151 of communication services platform 120.

At operation 402, processing logic sends requests for portions of end user data. In some embodiments, processing logic sends, via one or more application programming interface (API) calls), requests for portions of the end user data to one or more databases associated the client organization (e.g., third-party databases).

At operation 404, processing logic receives responses corresponding to the requests. In some embodiments, processing logic receives responses corresponding to the requests. In some embodiments, each of the responses identify a respective portion of the end user data.

At operation 406, processing logic stores the portions of the end user data at a data store associated with the SaaS platform. In some embodiments, prior to receiving the incoming voice call, processing logic stores the portions of the end user data at a data store associated with the SaaS platform.

At operation 408, processing logic receives an indication of an incoming voice call from a first telephone number associated with an end user device. In some embodiments, processing logic receives, at a software as a service (SaaS) platform, an indication of an incoming voice call from a first telephone number associated with an end user device and to a second telephone number associated with a client organization of the SaaS platform.

At operation 410, processing logic identifies end user data associated with the first telephone number. In some embodiments, responsive to receiving the indication of the incoming voice call, processing logic identifies end user data associated with the first telephone number.

In some embodiments, identifying the end user data associated with the telephone number includes identifying, among multiple end user data associated with the telephone number, a subset of end user data based on one or more second conditions defined by the client organization.

At operation 412, processing logic identifies a first communication service based on an evaluation of the end user data. In some embodiments, processing logic identifies, among multiple communication services, a first communication service based on an evaluation of the end user data in view of one or more first conditions defined by the client organization. In some embodiments, identifying, among the multiple communication services, the first communication service is based on an evaluation of the subset of end user data. In some embodiments, the multiple communication services include one or more an interactive voice response (IVR) service, a virtual artificial intelligence (AI) assistant service, and a human agent service.

In some embodiments, the first communication service includes a human agent service. In some embodiments, the evaluation of the end user data in view of the one or more first conditions defined by the client organization indicates the incoming voice call is to be escalated to the human agent service rather than an IVR service.

At operation 414, processing logic routes the incoming voice call to the first communication service. In some embodiments, processing logic routes the incoming voice call to the first communication service.

In some embodiments, the first communication service includes an interactive voice response service. In some embodiments, routing the incoming voice call to the first communication service includes transferring the incoming voice call to the interactive voice response service, and providing the end user data to the interactive voice response service. In some embodiments, the interactive voice response service is configured to execute interactive voice logic configured by the client organization and based at least in part on the end user data.

At operation 416, processing logic identifies additional end user data related to the incoming voice call. In some embodiments, subsequent to routing the incoming voice call to the first communication service, processing logic identifies additional end user data related to the incoming voice call.

In some embodiments, to identify the additional end user data, processing logic receives an indication of content of the incoming voice call. Processing logic performs sentiment analysis of the indication of content of the incoming voice call to determine a sentiment of the incoming voice call. In some embodiments, the client profile is updated with an indication of the sentiment of the incoming voice call.

In some embodiments, processing logic calculates a metric based at least in part on the additional end user data related to the incoming voice call. In some embodiments, the client profile is updated is updated with an indication of the calculated metric.

At operation 418, processing logic updates the client profile based on the additional end user data. In some embodiments, the client profile is associated with the end user data.

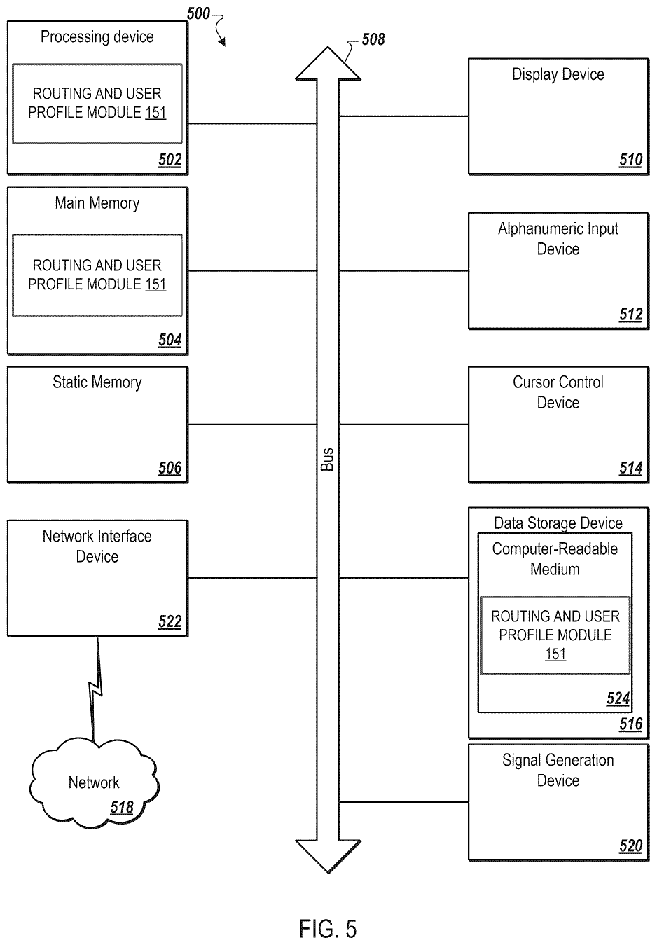

FIG. 5 is a block diagram illustrating an exemplary computer system 500, in accordance with an embodiment of the disclosure. The computer system 500 executes one or more sets of instructions that cause the machine to perform any one or more of the methodologies discussed herein. Set of instructions, instructions, and the like may refer to instructions that, when executed by computer system 500, cause computer system 500 to perform one or more operations of routing and user profile module 151. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 516, which communicate with each other via a bus 508.

The processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute instructions of the system architecture 100 and routing and user profile module 151 for performing the operations discussed herein.

The computer system 500 may further include a network interface device 522 that provides communication with other machines over a network 518, such as a local area network (LAN), an intranet, an extranet, or the Internet. The computer system 500 also may include a display device 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 516 may include a non-transitory computer-readable storage medium 524 on which is stored the sets of instructions of the system architecture 100 of routing and user profile module 151embodying any one or more of the methodologies or functions described herein. The sets of instructions of the system architecture 100 and of routing and user profile module 151may also reside, completely or at least partially, within the main memory 504 and/or within the processing device 502 during execution thereof by the computer system 500, the main memory 504 and the processing device 502 also constituting computer-readable storage media. The sets of instructions may further be transmitted or received over the network 518 via the network interface device 522.

While the example of the computer-readable storage medium 524 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that causes the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled. IN THE CLAIMS

What is claimed is:

1. A method, comprising:
receiving, at a software as a service (SaaS) platform, an indication of an incoming voice call from a first telephone number associated with an end user device and to a second telephone number associated with a client organization of the SaaS platform;
responsive to receiving the indication of the incoming voice call, identifying end user data associated with the first telephone number;
identifying, among a plurality of communication services, a first communication service based on an evaluation of the end user data in view of one or more first conditions defined by the client organization; and
routing the incoming voice call to the first communication service.

2. The method of claim 1, wherein the plurality of communication services comprises two or more of an interactive voice response (IVR) service, a virtual artificial intelligence (AI) assistant service, or a human agent service.

3. The method of claim 1, wherein the first communication service comprises an interactive voice response service, wherein routing the incoming voice call to the first communication service comprises:
transferring the incoming voice call to the interactive voice response service; and
providing the end user data to the interactive voice response service, the interactive voice response service configured to execute interactive voice logic configured by the client organization and based at least in part on the end user data.

4. The method of claim 1, wherein the first communication service comprises a human agent service, wherein the evaluation of the end user data in view of the one or more first conditions defined by the client organization indicates the incoming voice call is to be escalated to the human agent service rather than an IVR service.

5. The method of claim 1, wherein identifying the end user data associated with the telephone number comprises:
identifying, among a plurality of end user data associated with the telephone number, a subset of end user data based on one or more second conditions defined by the client organization, wherein identifying, among the plurality of communication services, the first communication service is based on an evaluation of the subset of end user data.

6. The method of claim 1, further comprising:
subsequent to routing the incoming voice call to the first communication service, identifying additional end user data related to the incoming voice call; and
updating a client profile based on the additional end user data, wherein the client profile is associated the end user data.

7. The method of claim 6, wherein identifying the additional end user data, comprises:
receiving an indication of content of the incoming voice call; and
performing sentiment analysis of the indication of content of the incoming voice call to determine a sentiment of the incoming voice call, wherein the client profile is updated with an indication of the sentiment of the incoming voice call.

8. The method of claim 6, further comprising:
calculating a metric based at least in part on the additional end user data related to the incoming voice call, wherein the client profile is updated with an indication of the calculated metric.

9. The method of claim 1, further comprising:
sending, via one or more application programming interface (API) calls), a plurality of requests for portions of the end user data to a plurality of databases associated the client organization;
receiving a plurality of responses corresponding to the plurality of requests, each of the plurality of responses identifying a respective portion of the end user data; and
prior to receiving the incoming voice call, storing the portions of the end user data at a data store associated with the SaaS platform.

10. A system, comprising:
a memory device; and
a processing device, coupled to the memory device, configured to perform operations comprising:
receiving, at the processing device of a software as a service (SaaS) platform, an indication of an incoming voice call from a first telephone number associated with an end user device and to a second telephone number associated with a client organization of the SaaS platform;
responsive to receiving the indication of the incoming voice call, identifying end user data associated with the first telephone number;
identifying, among a plurality of communication services, a first communication service based on an evaluation of the end user data in view of one or more first conditions defined by the client organization; and
routing the incoming voice call to the first communication service.

11. The system of claim 10, wherein the plurality of communication services comprises two or more of an interactive voice response (IVR) service, a virtual artificial intelligence (AI) assistant service, or a human agent service.

12. The system of claim 10, wherein the first communication service comprises an interactive voice response service, wherein routing the incoming voice call to the first communication service comprises:
transferring the incoming voice call to the interactive voice response service; and
providing the end user data to the interactive voice response service, the interactive voice response service configured to execute interactive voice logic configured by the client organization and based at least in part on the end user data.

13. The system of claim 10, wherein the first communication service comprises a human agent service, wherein the evaluation of the end user data in view of the one or more first conditions defined by the client organization indicates the incoming voice call is to be escalated to the human agent service rather than an IVR service.

14. The system of claim 10, wherein identifying the end user data associated with the telephone number comprises:
identifying, among a plurality of end user data associated with the telephone number, a subset of end user data based on one or more second conditions defined by the client organization, wherein identifying, among the plurality of communication services, the first communication service is based on an evaluation of the subset of end user data.

15. The system of claim 10, the operations further comprising:
subsequent to routing the incoming voice call to the first communication service, identifying additional end user data related to the incoming voice call; and
updating a client profile based on the additional end user data, wherein the client profile is associated the end user data.

16. The system of claim 15, wherein identifying the additional end user data, comprises:
receiving an indication of content of the incoming voice call; and
performing sentiment analysis of the indication of content of the incoming voice call to determine a sentiment of the incoming voice call, wherein the client profile is updated with an indication of the sentiment of the incoming voice call.

17. The system of claim 15, the operations further comprising:
calculating a metric based at least in part on the additional end user data related to the incoming voice call, wherein the client profile is updated with an indication of the calculated metric.

18. The system of claim 10, the operations further comprising:
sending, via one or more application programming interface (API) calls), a plurality of requests for portions of the end user data to a plurality of databases associated the client organization;
receiving a plurality of responses corresponding to the plurality of requests, each of the plurality of responses identifying a respective portion of the end user data; and
prior to receiving the incoming voice call, storing the portions of the end user data at a data store associated with the SaaS platform.

19. A non-transitory computer-readable medium comprising instructions that, responsive to execution by a processing device, cause the processing device to perform operations comprising:
receiving, at the processing device of a software as a service (SaaS) platform, an indication of an incoming voice call from a first telephone number associated with an end user device and to a second telephone number associated with a client organization of the SaaS platform;
responsive to receiving the indication of the incoming voice call, identifying end user data associated with the first telephone number;
identifying, among a plurality of communication services, a first communication service based on an evaluation of the end user data in view of one or more first conditions defined by the client organization; and
routing the incoming voice call to the first communication service.

20. The non-transitory computer-readable medium of claim 19, wherein the plurality of communication services comprises two or more of an interactive voice response (IVR) service, a virtual artificial intelligence (AI) assistant service, or a human agent service.
